(19) United States
(12) Patent Application Publication
(10) Pub. No.: US 2021/0176298 A1
(43) Pub. Date: Jun. 10, 2021

(54) PRIVATE CLOUD PROCESSING

(71) Applicant: GM GLOBAL TECHNOLOGY OPERATIONS LLC, Detroit, MI (US)

(72) Inventors: Anna Barnov, Tel Mond (IL); Eli Tzirkel-Hancock, Ra'anana (IL)

(73) Assignee: GM GLOBAL TECHNOLOGY OPERATIONS LLC, Detroit, MI (US)

(21) Appl. No.: 16/707,321

(22) Filed: Dec. 9, 2019

(51) Int. Cl. H04L 29/08; H04W 4/44; H04W 4/38

(52) U.S. Cl. CPC H04L 67/10; H04W 4/38; H04W 4/44

(57) ABSTRACT

A privacy system having at least one sensor and a device. The sensor may be operational to generate sensor data in response to a user. The device may be in communication with the sensor, in communication with multiple distributed cloud processing nodes, and operational to decompose the sensor data into multiple data items, transmit the multiple data items to the multiple distributed cloud processing nodes, receive multiple processed items from the multiple distributed cloud processing nodes, and generate output data based on the multiple processed items. Wherein individual ones of the multiple distributed cloud processing nodes are operational to generate a corresponding one of the multiple processed items in response to the corresponding one of the multiple data items, a privacy aspect of the user is indeterminable from individual ones of the multiple data items, and the privacy aspect of the user is determinable from the output data.

### INTRODUCTION

The present disclosure relates to a system and a method for private cloud processing.

Advanced vehicles are incorporating face monitoring, voice monitoring, posture assessment and detection of occupants inside the vehicles. The monitoring and detection features are used to facilitate autonomous driving applications, and advanced human machine applications. For example, the face recognition allows automatic validation of occupants in an autonomous fleet of vehicles. Occupant detection can determine if someone has been left alone in a back seat of a given vehicle.

Due to increased data rates and computational complexities, the applications increasingly rely on cloud computing. However, sending data related to the occupants into the cloud exposes the occupants to potential privacy violations. Even where the data is encrypted before being sent to the cloud, the data is no longer private after being decrypted in the cloud to permit neural-network operations. What is desired is a technique for cloud processing of occupant data with built in privacy protection.

### SUMMARY

A privacy system is provided herein. The privacy system comprises at least one sensor and a device. The at least one sensor is operational to generate sensor data in response to a user. The device is in communication with the at least one sensor, in communication with a plurality of distributed cloud processing nodes, and operational to decompose the sensor data into a plurality of data items, transmit the plurality of data items to the plurality of distributed cloud processing nodes, receive a plurality of processed items from the plurality of distributed cloud processing nodes, and generate output data based on the plurality of processed items. Individual ones of the plurality of distributed cloud processing nodes are operational to generate a corresponding one of the plurality of processed items in response to the corresponding one of the plurality of data items, a privacy aspect of the user is indeterminable from individual ones of the plurality of data items, and the privacy aspect of the user is determinable from the output data.

In one or more embodiments of the privacy system, the privacy aspect of the user is indeterminable from individual ones of the plurality of processed items.

In one or more embodiments of the privacy system, the decomposition of the sensor data comprises at least one of spatial decomposition and spectral decomposition of the sensor data.

In one or more embodiments of the privacy system, the decomposition of the sensor data comprises temporal decomposition of the sensor data.

In one or more embodiments of the privacy system, the device is operational to generate intermediate data by fusing the plurality of processed items.

In one or more embodiments of the privacy system, the device is operational to generate the output data by classifying the intermediate data.

In one or more embodiments of the privacy system, the fusing of the plurality of processed items comprises spatial fusing of the plurality of processed items.

In one or more embodiments of the privacy system, the fusing of the plurality of processed items comprises temporal fusing of the plurality of processed items.

In one or more embodiments of the privacy system, the sensor data comprises one or more of a video of the user, an image of the user, and audio generated by the user.

In one or more embodiments of the privacy system, the at least one sensor and the device are mountable in a vehicle, and the device communicates wirelessly with the plurality of distributed cloud processing nodes.

A method for cloud processing with privacy protection is provided herein. The method comprises: generating sensor data in response to a user; decomposing the sensor data into a plurality of data items using a device; transmitting the plurality of data items from the device to a plurality of distributed cloud processing nodes, wherein individual ones of the plurality of distributed cloud processing nodes are operational to generate a corresponding one of a plurality of processed items in response to the corresponding one of the plurality of data items, and a privacy aspect of the user is indeterminable from individual ones of the plurality of data items; receiving the plurality of processed items from the plurality of distributed cloud processing nodes at the device; and generating output data based on the plurality of processed items, wherein the privacy aspect of the user is determinable from the output data.

In one or more embodiments, the method further comprises generating intermediate data by fusing the plurality of processed items.

In one or more embodiments of the method, the output data is generated by classifying the intermediate data.

In one or more embodiments of the method, the sensor data comprises one or more of a video of the user, an image of the user, and audio generated by the user.

In one or more embodiments of the method, the device is mountable in a vehicle, and the device communicates wirelessly with the plurality of distributed cloud processing nodes.

A private cloud processing system is provided herein. The private cloud processing system comprising a network, at least one sensor, a device and a plurality of distributed cloud processing nodes. The at least one sensor is operational to generate sensor data in response to a user. The device is in communication with the at least one sensor and the network, and operational to decompose the sensor data into a plurality of data items, transmit the plurality of data items to the network, receive a plurality of processed items from the network, and generate output data based on the plurality of processed items. The plurality of distributed cloud processing nodes are in communication with the network. Individual ones of the plurality of distributed cloud processing nodes are operational to receive a corresponding one of the plurality of data items from the device through the network, generate a corresponding one of the plurality of processed items in response to the corresponding one of the plurality of data items, and transmit the corresponding one of the plurality of processed items to the device through the network. A privacy aspect of the user is indeterminable from individual ones of the plurality of data items, and the privacy aspect of the user is determinable from the output data.

In one or more embodiments, the private cloud processing system further comprises a network node operational to transfer the plurality of data items from the device to the plurality of distributed cloud processing nodes, and transfer the plurality of processed items from the plurality of distributed cloud processing nodes to the device.

In one or more embodiments of the private cloud processing system, the device comprises a transceiver operational to communicate wirelessly with the network node.

In one or more embodiments of the private cloud processing system, the individual ones of the plurality of distributed cloud processing nodes are operational to generate first internal data by spatially convoluting the corresponding one of the plurality of data items, generate second internal data by temporally convoluting the first internal data, and generate the corresponding one of the plurality of processed items by temporally fusing the second internal data.

In one or more embodiments of the private cloud processing system, the individual ones of the plurality of distributed cloud processing nodes are operational to generate third internal data by spectral binning the corresponding one of the plurality of data items, generate fourth internal data by temporally convoluting the third internal data, and generate the corresponding one of the plurality of processed items by temporally fusing the fourth internal data.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a private cloud processing system in accordance with an exemplary embodiment.

FIG. 2 is a schematic diagram of a device of the private cloud processing system in accordance with an exemplary embodiment.

FIG. 3 is a schematic diagram of a generic processing operation of the private cloud processing system in accordance with an exemplary embodiment.

FIG. 4 is a schematic diagram of a distributed machine learning operation in accordance with an exemplary embodiment.

FIG. 5 is a flow diagram of a method for private cloud processing in accordance with an exemplary embodiment.

FIG. 6 is a schematic diagram of a private video processing operation in accordance with an exemplary embodiment.

FIG. 7 is a schematic diagram of a private audio processing operation in accordance with an exemplary embodiment.

### DETAILED DESCRIPTION

Various embodiments of the disclosure provide a technique for protecting occupant privacy in applications where cabin content processing is aided by cloud computing. The technique generally involves distributed cloud-based machine learning where individual distributed cloud processing nodes receive a corresponding data portion (or data item) of the cabin content for processing. The data items may be parsed from the cabin content within the vehicle such that a privacy aspect(s) (e.g., identities, recognition, personal features and/or the like) of the occupant(s) cannot be detected at the individual distributed cloud processing nodes. Cloud processed data portions (or processed items) are subsequently returned to the vehicle. Meaningful processing that may facilitate identification of the occupant(s), recognition of the occupant(s) and/or determining personal features of the occupant(s) is possible after the processed items are merge locally back within the vehicle.

The individual distributed cloud processing nodes may perform processing and model adjustments on the data items. The data items may be configured inside the vehicle such that the privacy aspects of the occupants cannot be detected at the distributed cloud processing nodes. The data items may also be configured such that meaningful processing may be performed in the distributed cloud processing nodes. Merger of the processed items is limited to within the vehicle such that privacy information may be understood only inside the vehicle.

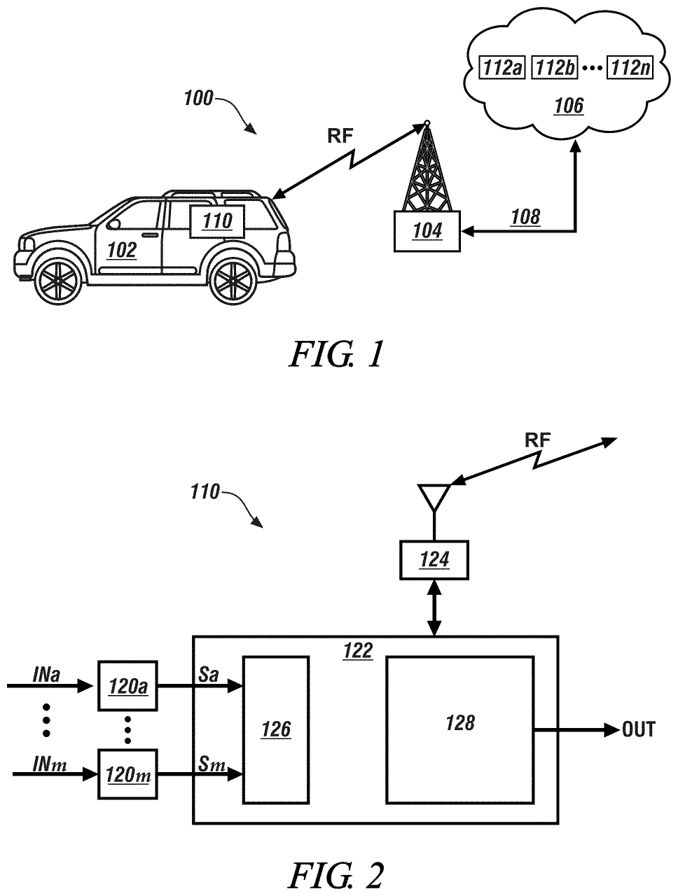

Referring to FIG. 1, a schematic diagram of an example implementation of a private cloud processing system 100 is shown in accordance with an exemplary embodiment. The private cloud processing system 100 generally comprises a vehicle 102, multiple network nodes 104 (one shown for clarity), a distributed processing cloud 106 and a network 108. The vehicle 102 may include a device 110. The distributed processing cloud 106 generally comprises multiple distributed cloud processing nodes 112a-112n.

A bidirectional radio-frequency signal (e.g., RF) may be exchanged between the device 110 and the network node 104. The radio-frequency signal RF generally conveys the data items from the device 110 to the network node 104 and the processed items from the network node 104 to the device 110. The data items and the processed items are generally configured such that the privacy aspects of the occupants (or users) of the vehicle 102 cannot be determined.

The vehicle 102 may be implemented as an automobile (or car). In various embodiments, the vehicle 102 may include, but is not limited to, a passenger vehicle, a truck, an autonomous vehicle, a gas-powered vehicle, an electric-powered vehicle, a hybrid vehicle, a motorcycle, a boat, a train and/or an aircraft. In some embodiments, the vehicle 102 may include stationary objects such as rooms, booths and/or structures suitable for one or more users to occupy. Other types of vehicles 102 may be implemented to meet the design criteria of a particular application.

The network nodes 104 may implement wireless transceiver nodes (or towers). The network nodes 104 are generally operational to communicate with the device 110 via the radio-frequency signal RF. The network nodes 104 may also be operational to communicate with the processing cloud 106 via the network 108. The data items received by the network nodes 104 from the device 110 in the radio-frequency signal RF may be presented to the processing cloud 106. The processed items received by the network nodes 104 from the processing cloud 106 may be relayed to the device 110. In various embodiments, the network nodes 104 may be implemented as cellular network nodes. In other embodiments, the network nodes 104 may be implemented as Wi-Fi network nodes and/or WiGig (60 GHz Wi-Fi) nodes. Other types of wireless nodes (or access points) may be implemented to meet a design criteria of a particular application.

The processing cloud 106 may implement a distributed collection of computers. The processing cloud 106 is generally operational to process the data items generated by the device 110 to create the processed items.

The network 108 may implement a backbone network. The network 108 may include one or more wired networks and/or one or more wireless networks. In various embodiments, the network 108 may include the Internet. The network 108 is generally operational to transfer data between the network nodes 104 and the processing cloud 106.

The device 110 may be implemented as an electronic circuit in the vehicle 102. The device 110 is generally operational to generate sensor data by sensing one or more characteristics (e.g., position, posture, voice, images, video, weight, etc.) of one or more users within the vehicle 102. The device 110 may decompose the sensor data into multiple data items. The data items may be decomposed (or parsed) such that the privacy aspects of the occupants cannot be determined from an individual data item. Thereafter, the device 110 may transmit the data items to the distributed cloud processing nodes 112a-112n through the network node 104 and the network 108. After the distributed cloud processing nodes 112a-112n have performed various transformations of the data items, the resulting processed items may be returned to the device 110 via the network 108 and the network node 104. Upon reception of the processed items, the device 110 may generate output data based on the processed items. The output data may be configured such that the privacy aspects (or privacy information) of the users may be determinable.

The distributed cloud processing nodes 112a-112n may implement a distributed set of computers operating independent of each other. Individual ones of the distributed cloud processing nodes 112a-112n are generally operational to generate a corresponding one of the processed items by performing one or more operations on a corresponding one of the data items. The operations may include, but are not limited to, video processing operations, still image (or picture) processing operations and/or audio processing operations.

Referring to FIG. 2, a schematic diagram of an example implementation of the device 110 is shown in accordance with an exemplary embodiment. The device 110 generally comprises one or more sensors 120a-120m, an electronic control unit 122 and a transceiver 124. The electronic control unit 122 may include a decomposition circuit (or block) 126 and a processing circuit (or block) 128. The decomposition circuit 126 and the processing circuit 128 may be implemented in hardware and/or software executing on the hardware.

One or more input signals (e.g., INa-INm) may be received by the sensors 120a-120m. The input signals INa-INm may be one or more video signals, one or more still image signals and/or one or more acoustic signals that carry input information. The sensors 120a-120m may generate sensor data signals (e.g., Sa-Sm) that are presented to the decomposition circuit 126. The sensor data signals Sa-Sm may convey digitized versions of the input information received in the input signals INa-INm. The processing circuit 128 may generate and present an output signal (e.g., OUT). The output signal OUT may carry the output data (e.g., the privacy aspect information of the users) to additional circuitry within the vehicle 102. The privacy aspect information (e.g., identification information, recognition information and/or personal feature information) may be used to facilitate validation applications, autonomous driving applications, advanced human machine applications and/or similar applications within the vehicle 102 that rely on knowing who is driving the vehicle and/or who is situated within the vehicle.

The sensors 120a-120m may implement a variety of image, video, acoustic, pressure and/or ultrasound sensors. The sensors 120a-120m are generally operational to sense characteristics of the users inside a cabin of the vehicle 102 and/or in near proximity outside the vehicle 102 (e.g., visible through a window). One or more video sensors (e.g., the sensor 120a) and/or one or more image sensors (e.g., the sensor 120b) may be operational in the visible spectrum and/or in the infrared spectrum. Other types of sensors may be implemented to meet a design criteria of a particular application.

The electronic control unit 122 may implement the electronic circuitry used to partially process the sensor information received in the sensor data signals Sa-Sm and finish processing the processed items to generate the output signal OUT. The partial processing of the sensor data signals Sa-Sm may include decomposition of the sensor information to generate multiple data items. The data items may be presented to the transceiver 124 for transmission in the radio-frequency signal RF outside the vehicle 102. The processed items may be received in the radio-frequency signal RF, through the transceiver 124, and transferred into the electronic control unit 122. The processed items may be fused together and classified to generate the output data. The output data may be presented in the output signal OUT.

The transceiver 124 may implement a bidirectional wireless transceiver. The transceiver 124 is generally operational to transmit the data items received from the electronic control unit 122 in the radio-frequency signal RF. The transceiver 124 is also operational to receive the processed items from the network nodes 104. The processed items may be provided to the electronic control unit 122 for the final processing.

The decomposition circuit 126 may implement electronic circuitry operational to receive the sensor signals Sa-Sm and decompose (or parse) the sensor information within into the data items. The type of decomposition performed generally depends on the type of sensor information. For example, video information may be parsed into different fields or frames, different slices within the fields/frames and/or different components of the slices. Image information may be parsed into different regions of the images and/or different components of the images. Audio information may be parsed into different time slices and/or different frequency components. In various embodiments, the decomposition circuit 126 may also be operational to perform spectral decomposition and/or other types of data decomposition.

The processing circuit 128 may implement electronic circuitry configured to generate the output signal OUT in response to the processed items received from the distributed cloud processing nodes 112a-112n via the transceiver 124. The processing circuit 128 is generally operational to fuse the processed items together and subsequently classify the fused processed items. The classification information may form the output data presented in the output signal OUT.

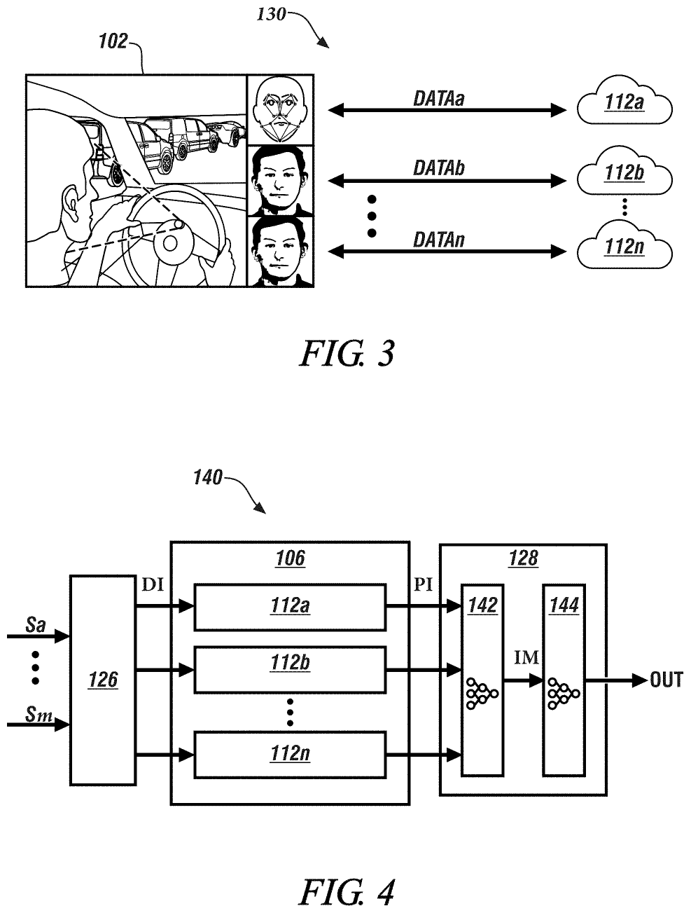

Referring to FIG. 3, a schematic diagram of an example generic processing operation 130 of the private cloud processing system 100 is shown in accordance with an exemplary embodiment. A video camera in a steering wheel of the vehicle 102 may capture a face of a driver. Multiple aspects of the resulting video (e.g., various luminance features and various chrominance features in spatially different locations and/or temporally different positions) may be captured by the device 110. The individual aspects may be divided into different data items (e.g., DATAa-DATAn) by the device 110 and transmitted to the distributed cloud processing nodes 112a-112n.

Individual ones of the distributed cloud processing nodes 112a-112n may receive corresponding ones of the data items for intermediate processing. The intermediate processing may include signal processing and/or model adjustment processing. The distributed cloud processing nodes 112a-112n generally get a partial representation of the cabin data such that the privacy aspects of the users cannot be detected at a single node, but meaningful processing is possible. In some embodiments, one or more distributed cloud processing nodes 112a-112n may receive and/or process multiple data items concurrently as long as the privacy of the users is maintained. The distributed cloud processing nodes 112a-112n may generate the processed items that are returned to the vehicle 102. Merging of the processed items may be performed locally in the vehicle 102. Therefore, the private information may be understood only by the electronic circuitry in the vehicle 102.

Referring to FIG. 4, a schematic diagram of an example implementation of a distributed machine learning operation 140 is shown in accordance with an exemplary embodiment. The sensor data signals Sa-Sm may be received by the decomposition circuit 126. The decomposition circuit 126 may generate multiple data item signals (e.g., DI) carrying the data items in response to the sensor information in the sensor data signals Sa-Sm. In various embodiments, a number of the sensor data signals Sa-Sm may be different than a number of data items. In some embodiments, the number of sensor data signals Sa-Sm may match the number of data items.

The data items may be transferred to the distributed cloud processing nodes 112a-112n in the processing cloud 106. The distributed cloud processing nodes 112a-112n may generate the processed items in response to the data items. The processed items may be transferred back to the device 120 in multiple processed item signals (e.g., PI).

The device 120 generally comprises a fusion circuit (or block) 142 and a classifier circuit (or block) 144. The fusion circuit 142 and the classifier circuit 144 may be implemented in hardware and/or software executing on the hardware.

The processed items may be received by the fusion circuit 142. The fusion circuit 142 may generate an intermediate signal (e.g., IM) that is conveyed to the classifier circuit 144. The intermediate signal IM may convey intermediate data within the processing circuit 128. The output signal OUT may be generated and presented by the classifier circuit 144.

The fusion circuit 142 may implement a spatial fusion circuit and/or spectral fusion circuit. The fusion circuit 142 is generally operational to combine the processed items received from the processing cloud 106 to create the intermediate data. The intermediate data may contain sufficient information that the users are recognizable (or distinguishable). The intermediate data may be presented in the intermediate signal IM to the classifier circuit 144.

The classifier circuit 144 is generally operational to perform one or more classification operations. The classification operation may be configured to determine the privacy aspects of the users. The classification operations may generate the output data in response to the intermediate data. The output data may be presented in the output signal OUT to other circuits within the vehicle 102.

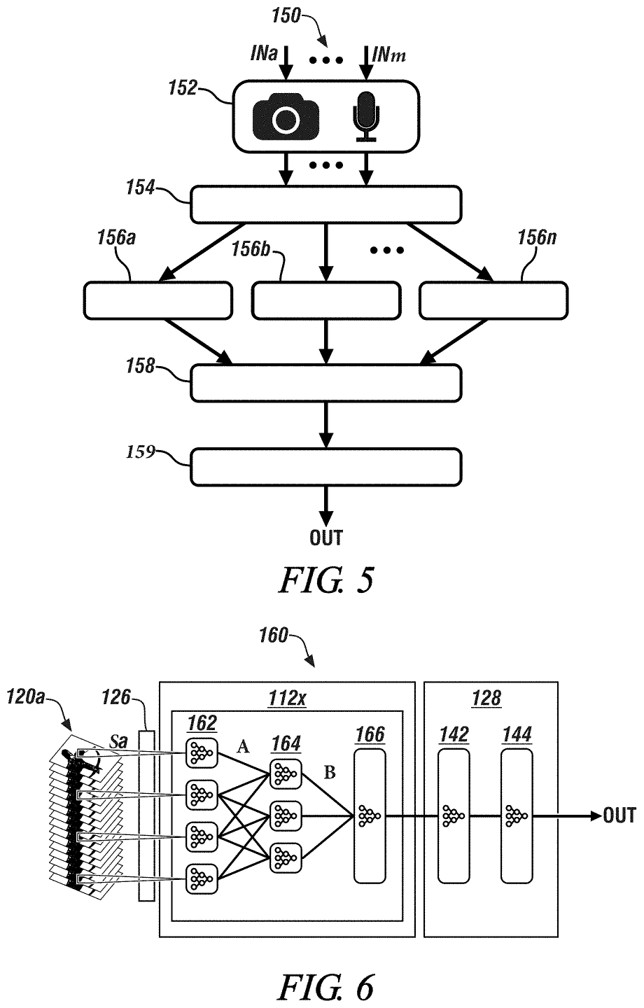

Referring to FIG. 5, a flow diagram of an example method 150 for private cloud processing is shown in accordance with an exemplary embodiment. The method (or process) 150 generally comprises a step 152, a step 154, multiple steps 156a-156n, a step 158 and a step 159. The sequence of steps 152 to 159 is shown as a representative example. Other step orders may be implemented to meet the criteria of a particular application.

In the step 152, the sensors 120a-120m may convert the input information (e.g., cabin content) received in the input signals INa-INm into electrical signals (e.g., the sensor information in the sensor data signals Sa-Sm) that are conveyed to the decomposition circuit 126. The decomposition circuit 126 may decompose the sensor information into privacy protected data items (or sub-components) inside the vehicle 102/the device 110 in the step 154. The data items may be transferred at the end of the step 154 to the distributed cloud processing nodes 112a-112n.

In the steps 156a-156n, the distributed cloud processing nodes 112a-112n may process the process data items concurrently (at N places in the cloud) to create the processed items. At the end of the steps 156a-156n, the processed items may be transferred back to the device 110 within the vehicle 102. In the step 158, the fusion circuit 142 may fuse the processed items together to create the intermediate data. The intermediate data may be processed further by the classifier circuit 144 in the step 159 to generate the output data in the output signal OUT.

Referring to FIG. 6, a schematic diagram of an example implementation of private video processing operation 160 is shown in accordance with an exemplary embodiment. The private video processing operation 160 may be a variation of the distributed machine learning operation 140.

A video sensor (e.g., the sensor 120a) may record a video sequence as the input information in the input signal INa. The sensor data signal Sa may be received by the decomposition circuit 126 where the video sequence is divided into the data items. The data items may be transmitted to the distributed cloud processing nodes 112a-112n. A particular distributed cloud processing node (e.g., 112x) may receive several data items from a similar spatial portion of the video sequence with the portions taken at different times in the sequence. Other spatial portions of the video sequence may be transferred to other ones of the distributed cloud processing nodes 112a-112n.

The particular distributed cloud processing node 112x may be configured as one or more spatial convolution nodes 162, one or more temporal convolution nodes 164 and one or more temporal fusion nodes 166. The spatial convolution nodes 162 may generate a first internal signal (e.g., A) transferred to the temporal convolution nodes 164. The first internal signal A may convey first internal data of the spatially convoluted video. A second internal signal (e.g., B) may be generated by the temporal convolution nodes 164 and transferred to the temporal fusion nodes 166. The second internal signal B may convey second internal data of the temporally convoluted first data. The other distributed cloud processing nodes 112a-112n may have a similar configuration.

The spatial convolution nodes 162 are generally operational to perform multidimensional (e.g., 3-dimensional) spatial convolutions on the data items received for the corresponding spatial portion. The spatial convolutions may generate the first internal data in response to the corresponding data items.

The temporal convolution nodes 164 are generally operational to perform temporal convolutions on the first internal data received from the spatial convolution nodes 162. The temporal convolution nodes 164 may generate the second internal data in response to the first internal data.

The temporal fusion nodes 166 may be operational to combine the second internal data received from the temporal convolution nodes 164 to generate a particular one of the processed items. The particular processed item may be transferred back to the fusion circuit 142 in the device 110.

The fusion circuit 142 may combine the particular processed item created by the particular distributed cloud processing node 112x with the other processed items created by the other distributed cloud processing nodes 112a-112n. The combined (e.g., intermediate) information may be transferred to the classifier circuit 144. The classifier circuit 144 is generally operational to classify the intermediate information to establish the output data in the output signal OUT.

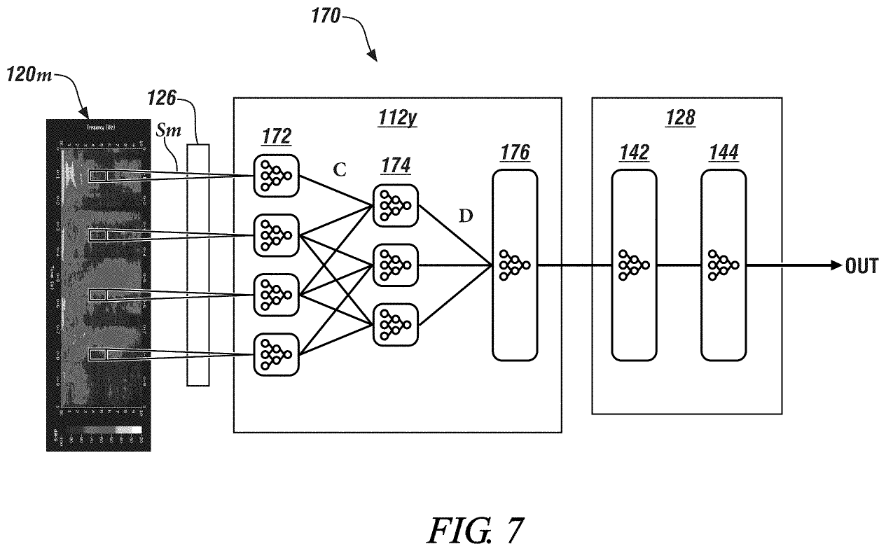

Referring to FIG. 7, a schematic diagram of an example implementation of private audio processing operation 170 is shown in accordance with an exemplary embodiment. The private audio processing operation 170 may be a variation of the distributed machine learning operation 140.

A microphone sensor (e.g., the sensor 120m) may record an audio signal as the input information in the input signal INm. The sensor data signal Sm may be received by the decomposition circuit 126 where a spectrogram (a spectrum of frequencies of the audio signal as the audio signal varies with time) is created from the audio signal and divided into the data items. The data items may be transmitted to the distributed cloud processing nodes 112a-112n. A particular distributed cloud processing node (e.g., 112y) may receive several data items from a similar frequency portion of the spectrogram with the portions taken at different times. Other frequency portions of the spectrogram may be transferred to other ones of the distributed cloud processing nodes 112a-112n.

The particular distributed cloud processing node 112y may be configured as one or more spectral bin nodes 172, one or more temporal convolution nodes 174 and one or more temporal fusion nodes 176. The spectral bin nodes 172 may generate a third internal signal (e.g., C) transferred to the temporal convolution nodes 174. The third internal signal C may convey third internal data of binned spectrogram information. A fourth internal signal (e.g., D) may be generated by the temporal convolution nodes 174 and transferred to the temporal fusion nodes 176. The fourth internal signal D may convey fourth internal data of the temporally convoluted third data. The other distributed cloud processing nodes 112a-112n may have a similar configuration.

The spectral bin nodes 172 are generally operational to allocate the data items into spectral bins. The spectral bins may create the third internal data in response to the corresponding data items.

The temporal convolution nodes 174 are generally operational to perform temporal convolutions on the first internal data received from the spectral bin nodes 172. The temporal convolution nodes 174 may generate the fourth internal data in response to the third internal data.

The temporal fusion nodes 176 may be operational to combine the fourth internal data received from the temporal convolution nodes 174 to generate a particular one or the processed items. The particular processed item may be transferred back to the fusion circuit 142 in the device 110.

The fusion circuit 142 may combine the particular processed item created by the particular distributed cloud processing node 112y with the other processed items created by the other distributed cloud processing nodes 112a-112n. The combined (e.g., intermediate) information may be transferred to the classifier circuit 144. The classifier circuit 144 is generally operational to classify the intermediate information to establish the output data in the output signal OUT.

Various embodiments of the system 100 may provide private cabin content processing in distributed cloud processing nodes 112a-112n. The cabin content may include video content, image content, audio content, ultrasound content and weights. The distributed cloud processing nodes 112a-112n may be operational to perform multidimensional (e.g., 3-dimensional) spatial convolutions, temporal convolutions, spectral binning, and temporal fusion. The data items transmitted to, and the processed items received from the distributed cloud processing nodes 112a-112n may be characterized in that the privacy aspects (e.g., identity, recognition and/or personal features) of the occupants of the vehicle 102 cannot be determined outside the vehicle 102 thus protecting the privacy of the occupants. Once the processed data is returned to the vehicle 102, the device 110 mounted in the vehicle 102 may fuse the processed data together and perform additional processing to establish output data. The output data may be characterized in that the privacy aspects of the occupants may be determinable from the output data thus enabling the vehicle 102 to respond to the privacy aspects of the driver and/or passengers.

While the best modes for carrying out the disclosure have been described in detail, those familiar with the art to which this disclosure relates will recognize various alternative designs and embodiments for practicing the disclosure within the scope of the appended claims.

What is claimed is:

1. A privacy system comprising:
at least one sensor operational to generate sensor data in response to a user;
a device in communication with the at least one sensor, in communication with a plurality of distributed cloud processing nodes, and operational to decompose the sensor data into a plurality of data items, transmit the plurality of data items to the plurality of distributed cloud processing nodes, receive a plurality of processed items from the plurality of distributed cloud processing nodes, and generate output data based on the plurality of processed items; and
wherein individual ones of the plurality of distributed cloud processing nodes are operational to generate a corresponding one of the plurality of processed items in response to the corresponding one of the plurality of data items, a privacy aspect of the user is indeterminable from individual ones of the plurality of data items, and the privacy aspect of the user is determinable from the output data.

2. The privacy system according to claim 1, wherein the privacy aspect of the user is indeterminable from individual ones of the plurality of processed items.

3. The privacy system according to claim 1, wherein the decomposition of the sensor data comprises spatial decomposition of the sensor data.

4. The privacy system according to claim 1, wherein the decomposition of the sensor data comprises at least one of temporal decomposition and spectral decomposition of the sensor data.

5. The privacy system according to claim 1, wherein the device is operational to generate intermediate data by fusing the plurality of processed items.

6. The privacy system according to claim 5, wherein the device is operational to generate the output data by classifying the intermediate data.

7. The privacy system according to claim 5, wherein the fusing of the plurality of processed items comprises spatial fusing of the plurality of processed items.

8. The privacy system according to claim 5, wherein the fusing of the plurality of processed items comprises temporal fusing of the plurality of processed items.

9. The privacy system according to claim 1, wherein the sensor data comprises one or more of a video of the user, an image of the user, and audio generated by the user.

10. The privacy system according to claim 1, wherein the at least one sensor and the device are mountable in a vehicle, and the device communicates wirelessly with the plurality of distributed cloud processing nodes.

11. A method for cloud processing with privacy protection, comprising:
generating sensor data in response to a user;
decomposing the sensor data into a plurality of data items using a device;
transmitting the plurality of data items from the device to a plurality of distributed cloud processing nodes, wherein individual ones of the plurality of distributed cloud processing nodes are operational to generate a corresponding one of a plurality of processed items in response to the corresponding one of the plurality of data items, and a privacy aspect of the user is indeterminable from individual ones of the plurality of data items;
receiving the plurality of processed items from the plurality of distributed cloud processing nodes at the device; and
generating output data based on the plurality of processed items, wherein the privacy aspect of the user is determinable from the output data.

12. The method according to claim 11, further comprising:
generating intermediate data by fusing the plurality of processed items.

13. The method according to claim 12, wherein the output data is generated by classifying the intermediate data.

14. The method according to claim 11, wherein the sensor data comprises one or more of a video of the user, an image of the user, and audio generated by the user.

15. The method according to claim 11, wherein the device is mountable in a vehicle, and the device communicates wirelessly with the plurality of distributed cloud processing nodes.

16. A private cloud processing system comprising:
a network;
at least one sensor operational to generate sensor data in response to a user;
a device in communication with the at least one sensor and the network, and operational to decompose the sensor data into a plurality of data items, transmit the plurality of data items to the network, receive a plurality of processed items from the network, and generate output data based on the plurality of processed items;
a plurality of distributed cloud processing nodes in communication with the network, individual ones of the plurality of distributed cloud processing nodes being operational to receive a corresponding one of the plurality of data items from the device through the network, generate a corresponding one of the plurality of processed items in response to the corresponding one of the plurality of data items, and transmit the corresponding one of the plurality of processed items to the device through the network; and
wherein a privacy aspect of the user is indeterminable from individual ones of the plurality of data items, and the privacy aspect of the user is determinable from the output data.

17. The private cloud processing system according to claim 16, further comprising a network node operational to transfer the plurality of data items from the device to the plurality of distributed cloud processing nodes, and transfer the plurality of processed items from the plurality of distributed cloud processing nodes to the device.

18. The private cloud processing system according to claim 17, wherein the device comprises a transceiver operational to communicate wirelessly with the network node.

19. The private cloud processing system according to claim 16, wherein the individual ones of the plurality of distributed cloud processing nodes are operational to generate first internal data by spatially convoluting the corresponding one of the plurality of data items, generate second internal data by temporally convoluting the first internal data, and generate the corresponding one of the plurality of processed items by temporally fusing the second internal data.

20. The private cloud processing system according to claim 16, wherein the individual ones of the plurality of distributed cloud processing nodes are operational to generate third internal data by spectral binning the corresponding one of the plurality of data items, generate fourth internal data by temporally convoluting the third internal data, and generate the corresponding one of the plurality of processed items by temporally fusing the fourth internal data.
